(19) United States
(12) Patent Application Publication
(10) Pub. No.: US 2007/0286492 A1
(43) Pub. Date: Dec. 13, 2007

(54) Method of extracting object from digital image by using prior shape information and system executing the method

(75) Inventors: Jung Bae Kim, Yongin-si (KR); Gengyu Ma, Beijing (CN); Ji Yeun Kim, Seoul (KR); Jiali Zhao, Beijing (CN); Haibing Ren, Beijing (CN)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/638,397

(22) Filed: Dec. 14, 2006

(30) Foreign Application Priority Data
Jun. 8, 2006 (KR) 10-2006-0051611

(51) Int. Cl. G06K 9/46

(52) U.S. Cl. 382/203

(57) ABSTRACT

A method of extracting a certain area from a digital image, the method including: combining image information and shape information based on an input image and prior shape information; and extracting a certain area from the input image by using the image information.

### CROSS-REFERENCE TO RELATED APPLICATION

This application claims priority from Korean Patent Application No. 10-2006-0051611, filed on Jun. 8, 2006, in the Korean Intellectual Property Office, the disclosure of which is incorporated herein by reference.

### BACKGROUND OF THE INVENTION

1. Field of the Invention

The present invention relates to a method of extracting an object from a digital image by using prior shape information and a system to execute the method, and more particularly, to a method of extracting a certain area from an inputted image by considering image information such as color, intensity, and shape information, and a system to execute the same.

2. Description of the Related Art

FIG. 1 is a diagram illustrating an example of an application field of a method of extracting an object from a digital image. As shown in FIG. 1, the method of extracting an object may be used to change a background of an object as shown in 101, extracting a plurality of objects from a plurality of digital images and combining the plurality of objects into one digital image as shown in 102, and hiding a background while performing image communication as shown in 103.

As conventional methods of extracting an object from a digital image, which can be variously applied as described above, there are a method using a contour of a desired object, namely, shape information of the object, and a method using image information.

There is a method of active shape model (ASM) as the method using the shape information of the object. The ASM is one of analytic feature extraction algorithms used in a process of receiving an input image and automatically adjusting features to reference points to be consistent with the input image. ASM is improved and developed from an active contour model (ACM), which searches for a feature of a new random image by using correlation of basic training sets having several features of an image model, via a repeated process.

In the case of the ACM, each of features includes internal energy smoothing a curve and external energy moving the curve to a contour of an image. However, the ACM is available to search for a contour of an image whose edge is definitely distinguished. However, since the ACM is not a transformation method based on a standard model, there is a limitation on detecting each feature of a face. Also, in the case of the ASM that is improved from the ACM, only several control points are detected from a contour of an object and a position of each of the control points is not precise.

As the method using the image information, there are a graph cut (min-cut) method, an intelligent scissors method, and a flood fill method.

FIG. 2 is a diagram illustrating a conventional min-cut method of extracting an object by using only image information. In the conventional min-cut method, a tri-map 202 labeling pixels in an input image 201 into three types (a foreground pixel, a background pixel, or an uncertain pixel) based on the input image 201 is acquired and min-cut 203 is performed based on the tri-map 202.

Since the min-cut method and the graph cut method are segmentation methods based on an n-link using a gradient and a t-link that is a weight image using a color histogram in which shape information is not used and connection with respect to only several peripheral pixels is considered, a result including a large amount of noise is acquired with respect to a complicated background.

The intelligent scissors method is a method of detecting an optimum locus along an edge of an input image. In the intelligent scissors method, since only gradient information is used, a locus may be disturbed with respect to a complicated image such as a pattern having a large number of edges.

Also, in the flood fill method, since shape information is not used, when an edge between two areas is vague, a background area is also filled instead of stopping at the edge.

### SUMMARY OF THE INVENTION

Additional aspects and/or advantages of the invention will be set forth in part in the description which follows and, in part, will be apparent from the description, or may be learned by practice of the invention.

An aspect of the present invention provides a method of extracting an object from a digital image by using shape information, and a system to execute the method.

An aspect of the present invention also provides a method and system for more smoothly extracting a certain area such as an object area from an input image by using a method of considering both of image information and shape information.

An aspect of the present invention also provides a method and system to extract a certain area, in which shape information is used as well as image information by including a distance map in a min-cut segmentation method and projecting a gradient to a norm vector of the shape information to acquire compatible edges from the shape information, thereby extracting the certain area as a smooth and ideal shape.

An aspect of the present invention also provides a method and system for more smoothly extracting a certain area by introducing a weight model expressing a weight map as prior shape information.

According to an aspect of the present invention, there is provided a method of extracting a certain area from a digital image, including: combining image information and shape information based on an input image and prior shape information; and extracting the certain area from the input image by using the image information.

The prior shape information may include a shape model and a weight model. The combining image information and shape information based on an input image and prior shape information may include: generating a shape constraint based on the input image and the shape model; generating a shape specified gradient image based on an approximate shape and a gradient image; and generating a shape specified weight image based on the input image, a tri-map of the input image and the weight model.

The shape model may express a contour of an object and may be formed of a line connecting a K number of control points. The weight model may express a weight map and may indicate a probability that each pixel expressing the object corresponds to a foreground pixel or a background pixel.

The generating a shape constraint based on the input image and the shape model may include: generating an approximate shape by using the input image and the shape model; and generating the shape constraint based on the approximate shape.

According to another aspect of the present invention, there is provided a system to extract a certain area from a digital image, including: a shape information combiner to combine image information and shape information based on an input image and prior shape information; and a certain area extractor to extract a certain area from the input image by using the image information.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating an example of an application field of a method of extracting an object from a digital image;

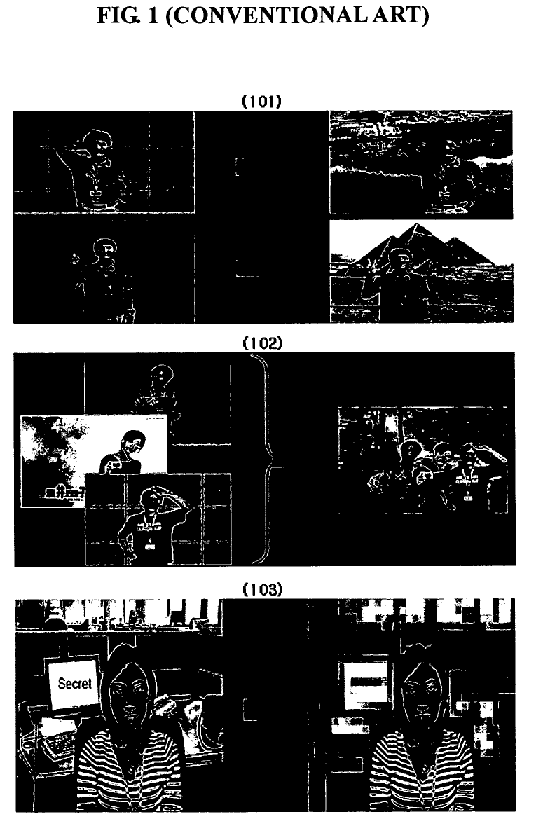

FIG. 2 is a diagram illustrating a conventional min-cut method of extracting an object by using only image information;

FIG. 3 is a schematic diagram illustrating a system to extract an object from a digital image by using prior shape information according to an embodiment of the present invention;

FIG. 4 is a flowchart illustrating a method of extracting a certain area from a digital image according to an embodiment of the present invention;

FIG. 5 is a diagram illustrating an example of prior shape information;

FIG. 6 is a diagram illustrating an example of a tri-map;

FIG. 7 is a flowchart illustrating a method of generating a shape constraint according to another embodiment of the present invention;

FIG. 8 is a diagram illustrating an example to describe a method of generating a shape constraint;

FIG. 9 is a flowchart illustrating a method of generating a shape specified gradient image according to an embodiment of the present invention;

FIG. 10 is a diagram illustrating an example to describe the method of generating a shape specified gradient image;

FIG. 11 is a flowchart illustrating a method of generating a shape specified weight image according to an embodiment of the present invention;

FIG. 12 is a flowchart illustrating a method of generating a connection to an uncertain pixel according to an embodiment of the present invention;

FIG. 13 is a diagram illustrating an example to describe a method of extracting a certain area;

FIG. 14 is a diagram illustrating an example to compare a certain area extracted by using prior shape information, with a certain area extracted without using the prior shape information;

FIG. 15 is a diagram illustrating another example to compare a certain area extracted by using prior shape information, with a certain area extracted without using the prior shape information; and

FIG. 16 is a block diagram illustrating an internal configuration of a certain area extraction system to extract a certain area from a digital image according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

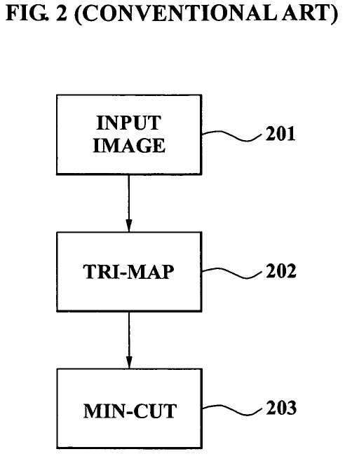

A conventional min-cut method uses only shape information of an input image as described referring to FIG. 2. However, according to an embodiment of present invention, an object is extracted by combining shape information as shown in a shape information combination 304 by using prior shape information 302, including a shape model and a weight model of an input image 301, and a tri-map 303 labeling pixels of the input image 301, and performing a min-cut method, thereby more smoothly extracting the object forming a certain area of the input image 301 that is a digital image, by using the shape information as well as image information.

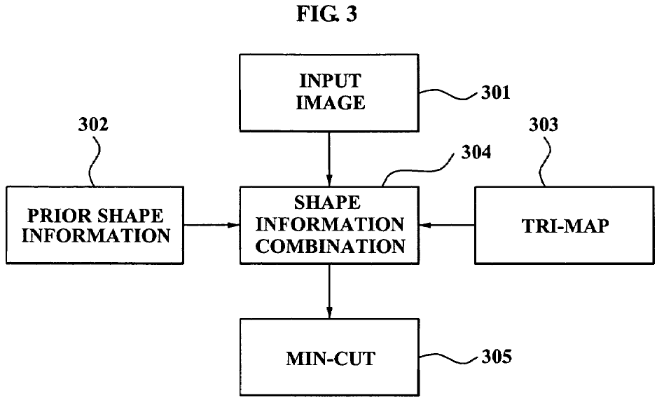

FIG. 3 is a schematic diagram illustrating a system to extract an object from a digital image by using prior shape information according to an embodiment of the present invention.

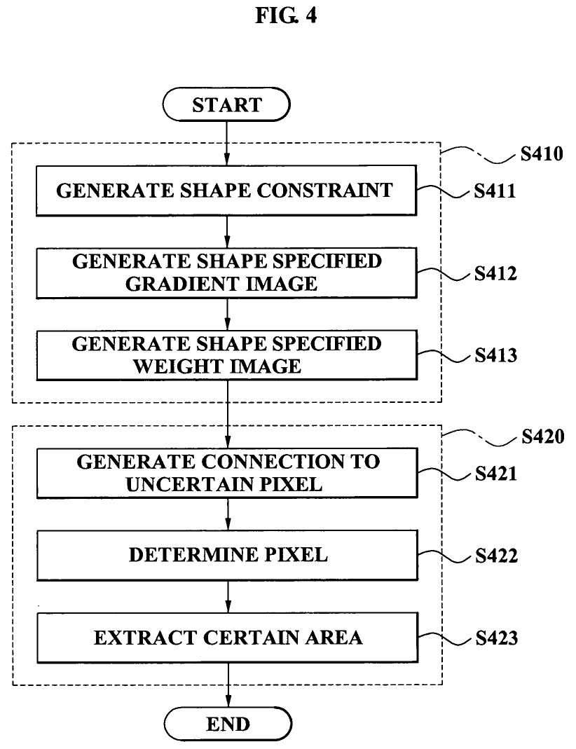

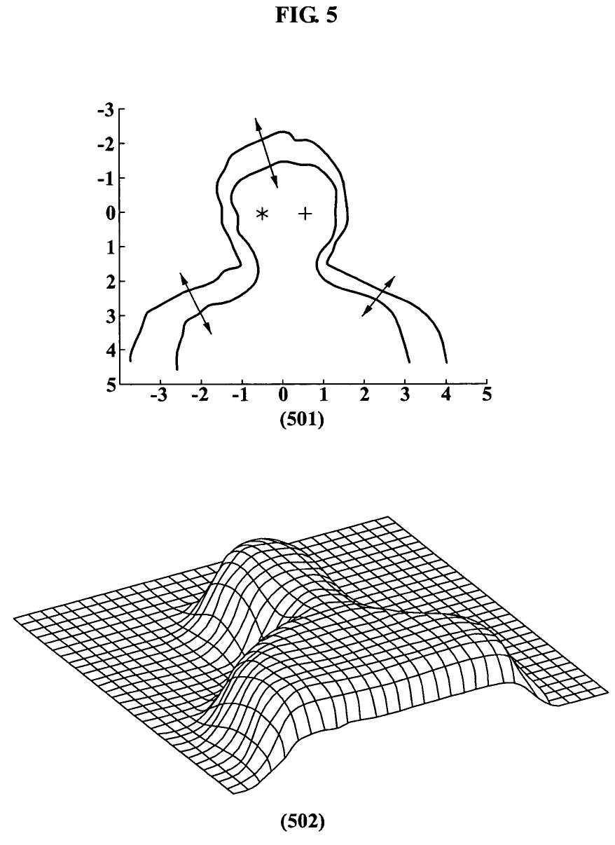

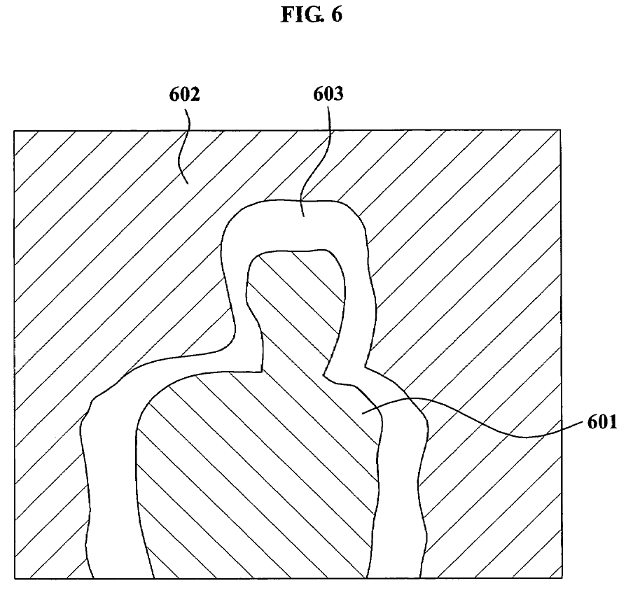

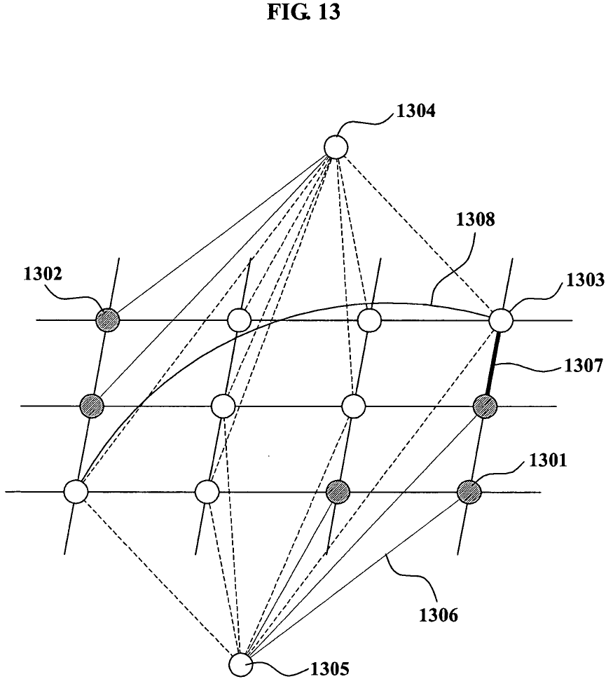

Hereinafter, a method of generating the prior shape information 302 and combining the shape information as shown in the shape information combination 304 will be described by referring to FIG. 4, FIG. 5, FIG. 6 or FIG. 13.

FIG. 4 is a flowchart illustrating a method of extracting a certain area from a digital image according to an embodiment of the present invention.

In operation S410, a certain area extraction system combines image information with shape information, based on an input image and prior shape information. In this case, the prior shape information may include a shape model and a weight model. Also, as shown in FIG. 4, operation S410 may include sub-operations S411 through 413.

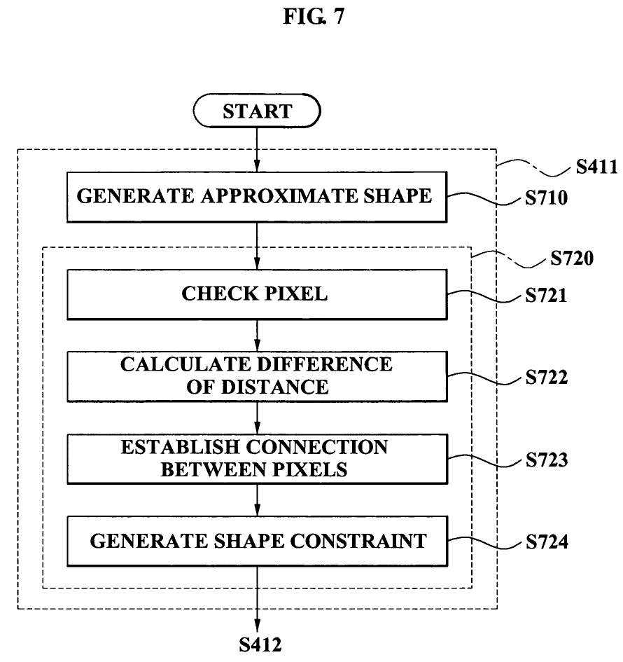

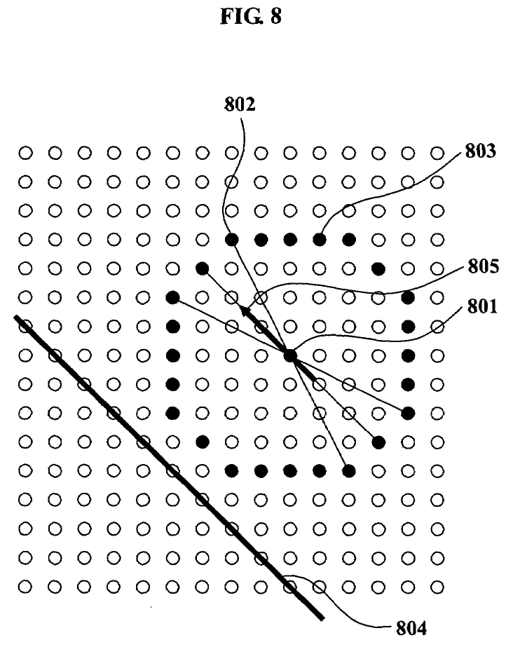

In sub-operation S411, the certain area extraction system generates a shape constraint based on the input image and the shape model. The shape constraint is made by establishing a connection to resist a cut between pixels separated by a certain distance, and a method of generating the shape constraint will be described in detail referring to FIGS. 7 and 8.

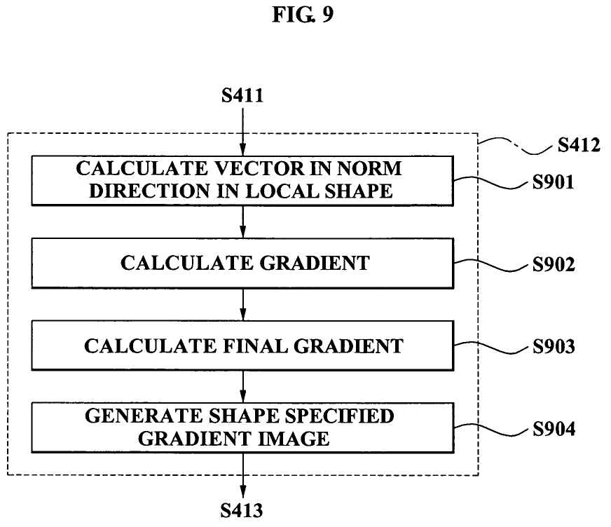

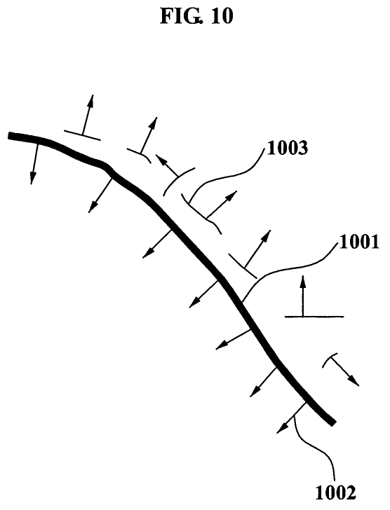

In sub-operation S412, the certain area extraction system generates a shape specified gradient image based on an approximate shape and a gradient image. The shape specified gradient image indicates that a gradient is projected to a vector in the norm direction of shape information to acquire a gradient image considering the shape information. A method of generating the shape specified gradient image will be described in detail referring to FIGS. 9 and 10.

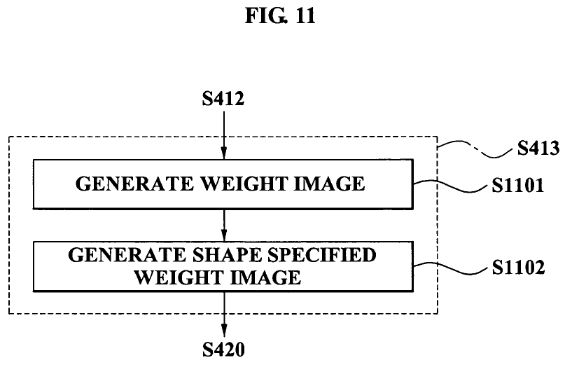

In sub-operation S413, the certain area extraction system generates a shape specified weight image based on the input image, a tri-map of the input image, and the weight model. The shape specified weight image is to smooth the certain area by using the weight model introduced to smooth a weight map. A method of generating the shape specified weight image will be described in detail referring to FIG. 11.

In operation S420, the certain area extraction system extracts the certain area from the input image by using the image information. In this case, as shown in FIG. 4, operation S420 may include sub-operations S421 through S423. In this case, the tri-map may label pixels of the input image into a foreground pixel, a background pixel, and an uncertain pixel.

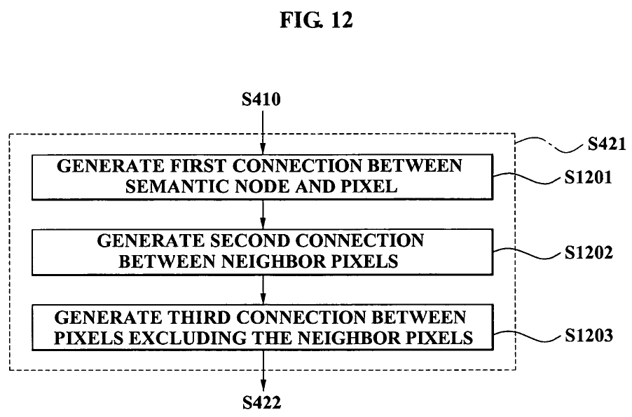

In sub-operation S421, the certain area extraction system generates a connection to the uncertain pixel by using the shape constraint, the shape specified gradient image, and the shape specified weight image. A method of generating the connection to the uncertain pixel will be described in detail referring to FIG. 12.

In sub-operation S422, the certain area extraction system determines the uncertain pixel to be the foreground pixel or the background pixel by removing a connection having weak intensity from a plurality of connections to the uncertain pixel.

In sub-operation S423, the certain area extraction system extracts the certain area by extracting only pixels determined to be the foreground pixel, from the input image.

The method of extracting the certain area, described referring to sub-operations S421 through S423 will be described in detail referring to FIG. 13.

FIG. 5 is a diagram illustrating an example of prior shape information. According to an embodiment of the present invention, the prior shape information may include a shape model 501 and a weight model 502.

The shape model 501 expresses a contour of an object and is formed of a line connecting a K number of control points. When the certain area is a figure, samples formed as described above may be arranged by using a position of eyes of the figure. Also, the shape model 501 may be used as a principal component analysis (PCA) model.

PCA is a method of contracting multidimensional data desired to be analyzed into two-dimensional or three-dimensional data by reducing loss of information included in the data. Applying the PCA, it can be visually recognized where an object of observation is located.

The weight model 502 expresses a weight map and indicates a probability that each pixel expressing the object corresponds to a foreground pixel or a background pixel. In this case, a weight exists in an N×M area, and an input dimension may be N×M and an output dimension may be L (L<<N×M). In this case, the weight model 502 may be also used for the PCA model.

FIG. 6 is a diagram illustrating an example of a tri-map. The tri-map labels pixels of an input image into a foreground pixel 601, a background pixel 602, and an uncertain pixel 603. The foreground pixel 601 may indicate a pixel that is a certain pixel of a certain area desired to be extracted from the input image. The background pixel 602 may indicate a pixel that is a certain pixel of a background that is not extracted from the input image.

Also, the uncertain pixel 603 may indicate a pixel that is not definitely determined to be the foreground pixel 601 or the background pixel 602. When definitely determining the uncertain pixel 603 to be the foreground pixel 601 or the background pixel 602, an edge of the certain area desired to be extracted may become smoother.

FIG. 7 is a flowchart illustrating a method of generating a shape constraint according to another embodiment of the present invention. As shown in FIG. 7, operations S710 and S720 may be performed within sub-operation S411 illustrated in FIG. 4.

In operation S710, the certain area extraction system generates an approximate shape by using an input image and a shape model of prior shape information. In this case, in operation S710, the approximate shape may be generated by an approximate shape generation module by using the input image and the shape model as an input. The approximate shape generation module may include an active shape model (ASM) method.

In operation S720, the certain area extraction system generates the shape constraint based on the approximate shape. In this case, operation S720 may include sub-operations S721 through S724.

In sub-operation S721, the certain area extraction system checks a pixel existing at a predetermined distance from the uncertain pixel of the tri-map. As a preparatory operation to compare a virtual line connecting the uncertain pixel and the pixel within the approximate shape, a connection in which a weight is given according to a degree of being parallel to the virtual line and being parallel to the approximate shape may be established via sub-operations S722 and S723.

In sub-operation S722, the certain area extraction system calculates a difference between a distance between the uncertain pixel and the approximate shape and a distance between the pixel and the approximate shape. The smaller the difference, the more parallel the virtual line and the approximate shape.

In sub-operation S723, the certain area extraction system establishes a connection to resist a cut between the uncertain pixel and the pixel, in which the difference is less than a predetermined value. Namely, the connection having a higher weight is established between two pixels forming the virtual line more similar to the approximate shape, generating the shape constraint, as shown in sub-operation S724.

In sub-operation S724, the certain area extraction system generates the shape constraint via the connection. In this case, the shape constraint may form a distance map to process the connection at high speed. The method of generating the shape constraint, described referring to sub-operations S721 through S724, will be described in detail referring to FIG. 8.

FIG. 8 is a diagram illustrating an example to describe the method of generating a shape constraint. To generate the shape constraint, pixels 802 and 803 at a certain distance from a certain pixel 801 are checked. It may be known that a virtual line connecting the pixel 801 and the pixel 802 from checked pixels is approximately parallel to a part of an approximate shape 804.

As described above, a connection to resist a cut between pixels in a direction similar to the approximate shape may be established. However, since a line connecting the pixel 801 and the pixel 803 is not in the direction similar to the part of the approximate shape 804, a connection is not established.

To recognize pixels in a similar direction and to more quickly calculate the connection, a distance map I_{Dist} is utilized. To give a greater weight to the connection between pixels having a direction similar to the part of the approximate shape 804, Equation 1 may be introduced.

Nₛₕₐₚₑ(p,q)=λ₁exp(−α₁·|I_{Dist}(p)−I_{Dist}(q)|) [Equation 1]

In a pixel p, I_{Dist}(P) indicates a distance from the pixel p to the part of the approximate shape 804. In this case, based on the pixel 801, a pixel to which a highest weight is given exists in a direction 805.

FIG. 9 is a flowchart illustrating a method of generating a shape specified gradient image according to an embodiment of the present invention. As shown in FIG. 9, operations S901 through S904 may be performed within sub-operation S412 illustrated in FIG. 4.

In operation S901, the certain area extraction system calculates a vector in the norm direction in each local shape with respect to the approximate shape. The vector in the norm direction may be used to generate the shape specified gradient image by combining a gradient image generated by convoluting a sobel filter in the directions of x coordinates and y coordinates with respect to the input image with prior shape information, in operation S902 and S903.

In operation S902, the certain area extraction system calculates a gradient with respect to each edge of the gradient image.

In operation S903, the certain area extraction system calculates a final gradient by using an inner product of the gradient and the vector in the norm direction. The inner product indicates projecting the gradient to the vector in the norm direction.

In operation S904, the certain area extraction system generates the shape specified gradient image by using the final gradient.

The method of generating the shape constraint described referring to operations S901 through S904 will be described in detail referring to FIG. 10.

FIG. 10 is a diagram illustrating an example to describe the method of generating a shape specified gradient image.

To generate the shape specified gradient image, a vector in the norm direction \vec{N} 1002 with respect to a part of an approximate shape 1001 is calculated and a gradient ∇I with respect to each edge 1003 is calculated.

A final gradient G may be calculated by projecting the gradient ∇I with respect to each edge 1003 to the vector in the norm direction 1002, namely, by using an inner product of the vector in the direction of the norm 1002 and the gradient ∇I, as shown in Equation 2.

G=∇I·\vec{N} [Equation 2]

With respect to an image having a C channel, an n-link of neighboring pixels p and q may be shown as Equation 3.

$${N}_{gradient} ( p , q ) = {λ}_{2} exp ( - {α}_{2} {{\sum }_{ch}}^{C} ( ∇ {I}_{p} \cdot {{N}^{->}}_{p} + ∇ {I}_{q} \cdot {{N}^{->}}_{q} ) ) \qquad [ Equation 3 ]$$

FIG. 11 is a flowchart illustrating a method of generating a shape specified weight image according to an embodiment of the present invention. As shown in FIG. 11, operations S1101 and S1102 may be performed within sub-operation S413 illustrated in FIG. 4.

In operation S1101, the certain area extraction system generates a weight image based on the input image and the tri-map. In this case, the weight image may include an image to which a probability of an uncertain pixel of the tri-map to a foreground pixel and a background pixel is given as a weight.

When histograms of the foreground pixel and the background pixel are HFore and HBack, respectively, a weight in the uncertain pixel p=(x, y) may be defined as shown in Equation 4.

$$T ( p , F ) = {λ}_{3} \frac{{H}_{Fore} ( I ( x , y ) )}{{H}_{Back} ( I ( x , y ) )} , \\ T ( p , B ) = {λ}_{3} ( 1 - \frac{{H}_{Fore} ( I ( x , y ) )}{{H}_{Back} ( I ( x , y ) )} ) \qquad [ Equation 4 ]$$

The weight indicates a t-link with respect to the foreground pixel and the background pixel, and F and B indicate a foreground and a background, respectively.

In operation S1102, the certain area extraction system generates the shape specified weight image based on the weight image and the weight model 502. In this case, the shape specified weight image may include an image made by transforming the weight image to be more consistent with the weight model. In this case, as an example of transformation of the image, PCA may be used.

FIG. 12 is a flowchart illustrating a method of generating a connection to an uncertain pixel according to an embodiment of the present invention. As shown in FIG. 12, operations S1201 and S1202 may be performed within sub-operation S421 illustrated in FIG. 4.

In operation S1201, the certain area extraction system generates a first connection between a predetermined semantic node and a pixel by using the shape specified weight image. In this case, the semantic node may include a semantic background and a semantic foreground. In addition, the semantic background may determine a connection with respect to a background weight of the pixel, and the semantic foreground may determine a connection with respect to a foreground weight of the pixel.

In operation S1202, the certain area extraction system generates a second connection between neighboring pixels by using the shape specified gradient image. The second connection has been described in detail referring to FIGS. 9 and 10 referred to describing the method of generating the shape specified gradient image by combining a gradient image using image information with prior shape information.

In operation S1203, the certain area extraction system generates a third connection between pixels excluding neighboring pixels by using the shape constraint. In this case, the third connection may be generated with respect to the pixels existing at a certain distance from each other, as described referring to FIGS. 7 and 8.

FIG. 13 is a diagram illustrating an example to describe a method of extracting a certain area. In each pixel of an input image, labeled into a foreground pixel 1301, a background pixel 1302, and an uncertain pixel 1303 by a tri-map, a connection between pixels is established by the described shape specified weight image, shape specified gradient image, and shape constraint.

As shown in FIG. 13, in the semantic background node 1304, a weight, illustrated as a solid line, given to the background pixel 1302 that has a value greater than another weight, illustrated as a dotted line, given to the uncertain pixel 1303. Also, in the semantic foreground node 1305, a weight, illustrated as a solid line, given to the foreground pixel 1301 has a value greater than another weight, illustrated as a dotted line, given to the uncertain pixel 1303. In this case, connection strength of the connection 1306 may be determined by using the weight.

The connection by the shape specified gradient image may be determined by using a connection 1307 between two neighboring pixels. In this case, connection strength of the connection 1307 may be determined by a final gradient, as described referring to FIGS. 9 and 10.

Finally, the connection by the shape constraint may be determined by a connection 1308 between pixels excluding neighboring pixels. Connection strength of the connection 1308 may be determined by a weight calculated via Equation 1 as described referring to FIGS. 7 and 8.

As described above, when excluding the connection whose connection strength is weak from the connections 1306, 1307, and 1308, the uncertain pixel 1303 may be determined to be the foreground pixel 1301 or the background pixel 1302.

As described above, in the method of extracting a certain area, which is described referring to FIGS. 3 through 13, all pixels of the input image are determined to be a foreground pixel or a background pixel and only the foreground pixel is extracted from the pixels, thereby extracting the certain area from the input image.

As described above, a certain area such as an object area may be more smoothly extracted from an input image by using the method of extracting the certain area from the input image by using the prior shape information, namely, the method of considering both image information and the shape information. The certain area may be extracted as a smoother and more ideal shape by using shape information as well as image information by including a distance map in the min-cut segmentation method and projecting a gradient to a norm vector of the shape information to acquire compatible edges from the shape information. In addition, the certain area may be more smoothly extracted by introducing a weight model expressing a weight map as the prior shape information.

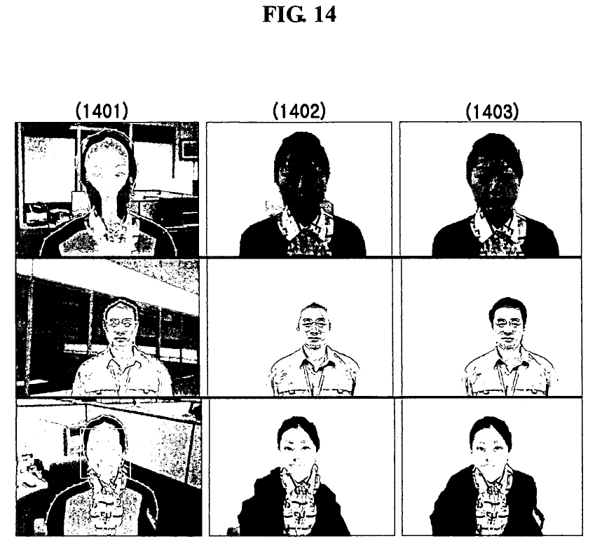

FIG. 14 is a diagram illustrating an example to compare a certain area extracted by using prior shape information with a certain area extracted without using the prior shape information.

In pre-processed images 1401, an input image in which a tri-map and an approximate image are displayed is shown. In images without shape information 1402, a result of extracting a certain area without using prior shape information is shown. As shown in FIG. 14, it may be seen that an extracted certain area is not smooth and there is a great amount of noise in the result when not using the prior shape information.

However, it may be seen that a result of extracting the certain area by using the prior shape information as shown in images with shape information 1403 is smoother and clearer than the result of 1402.

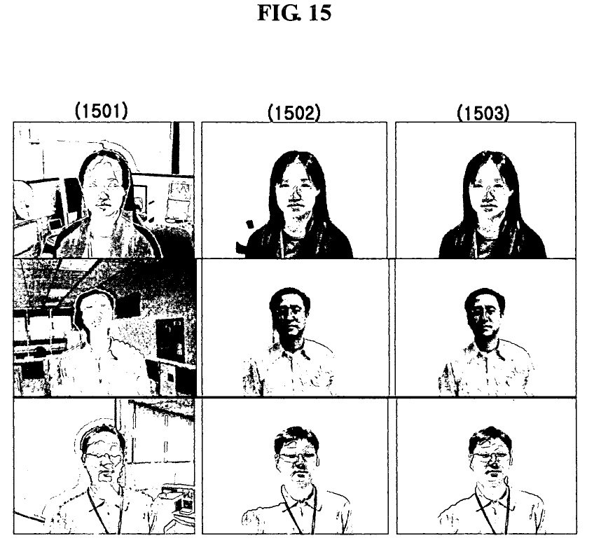

FIG. 15 is a diagram illustrating another example to compare a certain area extracted by using prior shape information with a certain area extracted without using the prior shape information.

Similarly to FIG. 14, in FIG. 15, an input image in which a tri-map and an approximate shape is displayed in pre-processed images 1501, a result of extracting of a certain area without using prior shape information is shown in images without shape information 1502, and a result of extracting the certain area by using the prior shape information is shown in images with shape information 1503.

In this case, it may be seen that the result of extracting show in images with shape information 1503 is smoother and clearer than the result of extracting shown in images without shape information 1502.

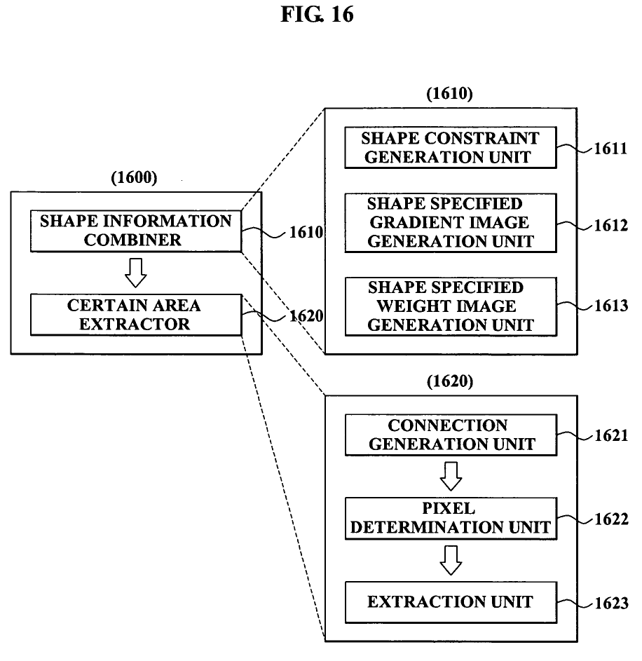

FIG. 16 is a block diagram illustrating an internal configuration of a certain area extraction system 1600 to extract a certain area from a digital image according to another embodiment of the present invention. As shown in FIG. 16, the certain area extraction system 1600 may include a shape information combiner 1610 and a certain area extractor 1620.

The shape information combiner 1610 combines image information with shape information based on an input image and prior shape information. In this case, the shape information combiner 1610 may include a shape constraint generation unit 1611 to generate a shape constraint based on the input image and a shape model, a shape specified gradient image generation unit 1612 to generate a shape specified gradient image based on an approximate shape and a gradient image, and a shape specified weight image generation unit 1613 to generate a shape specified weight image based on the input image, a tri-map of the input image, and a weight model.

As described above, the shape information combiner 1610 generates the shape constraint, the shape specified gradient image, and the shape specified weight image by combining the prior shape information including the shape model expressing a contour of an object and formed of a line connecting a K number of control points and the weight model expressing a weight map indicating a probability that each pixel expressing the object corresponds to a foreground pixel or a background pixel, with the input image together with the tri-map, thereby performing a preparatory process to extract the certain area from the input image.

The certain area extractor 1620 extracts the certain area from the input image by using the image information. In this case, the certain area extractor 1620 may extract the certain area from the input image, based on the shape constraint, the shape specified gradient image, and the shape specified weight image.

In this case, the certain area extractor 1620 may include a connection generation unit 1621 to generate a connection to an uncertain pixel by using the shape constraint, the shape specified gradient image, and the shape specified weight image, a pixel determination unit 1622 to determine the uncertain pixel to be a foreground pixel or a background pixel by removing a connection whose intensity is weak, from a plurality of connections to the uncertain pixel, and an extraction unit 1623 to extract the certain area by extracting only pixels determined to be the foreground pixel from the input image.

Also, the connection generation unit 1621 may include a first connection acquirer to generate a first connection between a predetermined semantic node and a pixel by using the shape specified weight image, a second connection acquirer to generate a second connection between neighboring pixels by using the shape specified gradient image, and a third connection acquirer to generate a third connection between pixels excluding neighboring pixels by using the shape constraint.

As described above, the certain area extractor 1620 may extract the certain area from the input image by using the prior shape information via the method in which a connection of the uncertain pixel is acquired by using the shape constraint, the shape specified gradient image, and the shape specified weight image, generated by the shape information combiner 1610, a connection whose intensity is weak is excluded, the uncertain pixel is definitely determined to be the foreground pixel or the background pixel, and only the foreground pixel is extracted.

The embodiments according to the present invention may be embodied as a program instruction capable of being executed via various computer units and may be recorded in a computer-readable recording medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level language codes that may be executed by the computer using an interpreter. The hardware elements above may be configured to act as one or more software modules to implement the operations of this invention.

An aspect of the present invention also provides a method and system for more smoothly extracting a certain area such as an object area from an input image by using a method of considering both of image information and shape information.

An aspect of the present invention also provides a method and system to extract a certain area, in which shape information is used as well as image information by including a distance map in a min-cut segmentation method and projecting a gradient to a norm vector of the shape information to acquire compatible edges from the shape information, thereby extracting the certain area as a smooth and ideal shape.

An aspect of the present invention also provides a method and system for more smoothly extracting a certain area by introducing a weight model expressing a weight map as prior shape information.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of extracting a certain area from a digital image, comprising:
combining image information and shape information based on an input image and prior shape information; and
extracting a certain area from the input image by using the image information.

2. The method of claim 1, wherein the prior shape information comprises a shape model and a weight model.

3. The method of claim 1, wherein the combining image information and shape information based on an input image and prior shape information comprises:
generating a shape constraint based on the input image and the shape model;
generating a shape specified gradient image based on an approximate shape and a gradient image; and
generating a shape specified weight image based on the input image, a tri-map of the input image, and the weight model.

4. The method of claim 2, wherein:
the shape model expresses a contour of an object and is formed of a line connecting a K number of control points.

5. The method of claim 2, wherein:
the weight model expresses a weight map and indicates a probability that each pixel expressing the object corresponds to a foreground pixel or a background pixel.

6. The method of claim 3, wherein the generating a shape constraint based on the input image and the shape model comprises:
generating the approximate shape by using the input image and the shape model; and
generating the shape constraint based on the approximate shape.

7. The method of claim 6, wherein the generating the shape constraint based on the approximate shape comprises:
checking a pixel existing at a predetermined distance from an uncertain pixel of the tri-map;
calculating a difference between a distance between the uncertain pixel and the approximate shape and a distance between the pixel and the approximate shape;
establishing a connection to resist a cut between the approximate pixel and the pixel whose difference is less than a predetermined difference value; and
generating the shape constraint by using the connection.

8. The method of claim 6, wherein the generating the approximate shape by using the input image and the shape model comprises generating the approximate shape by an approximate shape generation module into which the input image and the shape model are inputted, the approximate shape generation module using an active shape model (ASM) method.

9. The method of claim 6, wherein the shape constraint forms a distance map to process the connection at high speed.

10. The method of claim 2, wherein the generating a shape specified gradient image based on an approximate shape and a gradient image comprises:
calculating a vector in a direction of norm in each local shape with respect to the approximate shape;
calculating a gradient with respect to each edge of the gradient image;
calculating a final gradient by using an inner product of the gradient and the vector in the direction of norm; and
generating the shape specified gradient image by using the final gradient.

11. The method of claim 10, wherein the gradient image is generated by convoluting a sobel filter in directions of x coordinates and y coordinates with respect to the input image.

12. The method of claim 3, wherein the generating a shape specified weight image based on the input image, a tri-map, and the weight model comprises:
generating a weight image based on the input image and the tri-map; and
generating the shape specified weight image based on the weight image and the weight model.

13. The method of claim 12, wherein:
the weight image includes an image to which a probability of the foreground pixel and the background pixel with respect to the uncertain pixel of the tri-map is given as a weight

14. The method of claim 12, wherein:
the shape specified weight image includes an image made by transforming the weight image to be consistent with the weight model.

15. The method of claim 1, wherein the extracting a certain area from the input image by using the image information comprises extracting the certain area from the input image, based on the shape constraint, the shape specified gradient image, and the shape specified weight image.

16. The method of claim 1, wherein the tri-map labels a pixel of the input image as a foreground pixel, a background pixel, or an uncertain pixel.

17. The method of claim 16, wherein:
the extracting the certain area from the input image, based on the shape constraint, the shape specified gradient image, and the shape specified weight image comprises:
generating a connection to the uncertain pixel by using the shape constraint, the shape specified gradient image, and the shape specified weight image;
determining the uncertain pixel to be the foreground pixel or the background pixel by removing a connection having low intensity from a plurality of connections with respect to the uncertain pixel; and
extracting the certain area by extracting the pixel determined to be the foreground pixel from the input image.

18. The method of claim 17, wherein the generating a connection to the uncertain pixel by using the shape constraint, the shape specified gradient image, and the shape specified weight image comprises:
generating a first connection between a predetermined semantic node and a pixel by using the shape specified weight image;
generating a second connection between neighboring pixels by using the shape specified gradient image; and
generating a third connection between pixels excluding the neighboring pixels by using the shape constraint.

19. The method of claim 18, wherein:
the semantic node includes a semantic background and a semantic foreground; and
the semantic background determines a connection with respect to a background weight of the pixel and the semantic foreground determines a connection with respect to a foreground weight of the pixel.

20. A computer-readable recording medium in which a program to execute a method of extracting a certain area from a digital image is recorded, the method comprising:
combining image information and shape information based on an input image and prior shape information; and
extracting a certain area from the input image by using the image information.

21. A system to extract a certain area from a digital image, comprising:
a shape information combiner combining image information and shape information based on an input image and prior shape information; and
a certain area extractor extracting a certain area from the input image by using the image information.

22. The system of claim 21, wherein:
the prior shape information comprises a shape model and a weight model.

23. The system of claim 21, wherein:
the shape information combiner comprises:
a shape constraint generation unit generating a shape constraint based on the input image and the shape model;
a shape specified gradient image generation unit generating a shape specified gradient image based on an approximate shape and a gradient image; and
a shape specified weight image generation unit generating a shape specified weight image based on the input image, a tri-map, and the weight model.

24. The system of claim 21, wherein the certain area extractor extracts the certain area from the input image, based on the shape constraint, the shape specified gradient image, and the shape specified weight image.

25. The system of claim 21, wherein:
the tri-map labels a pixel of the input image as a foreground pixel, a background pixel, or an uncertain pixel.

26. The system of claim 21, wherein:
the certain area extractor comprises:
a connection generation unit generating a connection to the uncertain pixel by using the shape constraint, the shape specified gradient image, and the shape specified weight image;
a pixel determination unit determining the uncertain pixel to be the foreground pixel or the background pixel by removing a connection having low intensity from a plurality of connections with respect to the uncertain pixel; and
an extraction unit extracting the certain area by extracting, from the input image, the pixel determined to be the foreground pixel.

27. The system of claim 26, wherein the connection generation unit comprises:
a first connection acquirer generating a first connection between a predetermined semantic node and a pixel by using the shape specified weight image;
a second connection acquirer generating a second connection between neighboring pixels by using the shape specified gradient image; and
a third connection acquirer generating a third connection between pixels excluding the neighboring pixels by using the shape constraint.
